(19) United States
(12) Patent Application Publication
(10) Pub. No.: US 2026/0233914 A1
(43) Pub. Date: Aug. 13, 2026

(54) CONSUMER PRODUCT PACKAGE

(71) Applicant: The Gillette Company LLC, Boston, MA (US)

(72) Inventors: HyungJoo Lee, Kronberg (DE); Julia Lee, Brooklyn, NY (US); Jiong Hui Li, Braintree, MA (US); Christopher Ramm, North Attleboro, MA (US); Armando Miguel Hurtado, Boston, MA (US); Maria Eduarda Kruger, Sao Paulo (BR)

(21) Appl. No.: 19/533,869

(22) Filed: Feb. 9, 2026

Related U.S. Application Data
(60) Provisional application No. 63/756,446, filed on Feb. 10, 2025.

(51) Int. Cl. B65D 77/30; B31B 50/02; B65D 77/04

(52) U.S. Cl. CPC B65D 77/30; B31B 50/02; B65D 77/0433

(57) ABSTRACT

A consumer product package with a cavity dimensioned to receive a product. The consumer product package has a first panel and a second panel extending in a transverse direction from the first panel. An edge is positioned between the first panel and the second panel. A first weakened portion defines a tear away region to expose the cavity. The second weakened portion extends from the edge into at least a portion of the first panel. A second weakened portion defines a punch out tab extending from the edge into at least a portion of the second panel. A third panel is positioned over the second panel. The third panel defines a cut away region exposing the punch out tab. The punchout tab and the tear away region are integral.

### FIELD OF THE INVENTION

The present invention relates to packages for consumer products and more particularly, to consumer product packages with easy open features to facilitate access to the contents of the package.

### BACKGROUND OF THE INVENTION

Consumer product companies and retailers typically use plastic blister packages because they are more difficult for shoplifters to tear open. However, due to mounting global concerns about the environment, it has become desired for producers to adopt eco-friendly packaging. Plastic packages also frustrate legitimate consumers because of the difficulty of opening the package without the aid of a sharp tool. Accordingly, more packages are being designed with paper based materials and easy opening features. For example, packages may include perforated lines in at least one of the walls making up the package. The perforated lines are arranged to be broken by pulling on portions of the package adjacent those lines to provide access to the contents of the package. Despite the use of known packaging techniques, there remains a need to further modify consumer product packages for containing and displaying an item of merchandise, where the package is simple in construction and is intuitive and easy to open, as well as proving other benefits.

### SUMMARY OF THE INVENTION

In one aspect, the invention features, in general, a consumer product package having a cavity dimensioned to receive a product. The consumer product package has a first panel and a second panel extending in a transverse direction from the first panel. An edge is positioned between the first panel and the second panel. A first weakened portion defines a tear away region to expose the cavity. The second weakened portion extends from the edge into at least a portion of the first panel. A second weakened portion defines a punch out tab extending from the edge into at least a portion of the second panel. A third panel is positioned over the second panel. The third panel defines a cut away region exposing the punch out tab. The punchout tab and the tear away region is integral.

In another aspect, the invention features, in general, a method of forming a consumer product box defining a cavity dimensioned to receive a product by forming a first weakened portion defining a tear away region in at least a portion of the first panel to expose the cavity. A second weakened portion is formed with the second weakened portion defining a punch out tab in at least a portion of a second panel that is transverse to and integral with the first panel. The first panel is covered with a third panel. A cut away region defined by the third panel is positioned around the punch out tab exposing the punch out tab.

### BRIEF DESCRIPTION OF THE DRAWINGS

FIG. 1 is a bottom, rear perspective view of one possible embodiment of consumer product package.

FIG. 2 is a rear perspective view of the consumer product package of FIG. 1 in an open position.

FIG. 3 is a top view of a sheet of formable material of the consumer product package of FIG. 1.

FIG. 4 is a bottom, rear perspective view of the consumer product package of FIG. 1 in a partially folded position.

FIG. 5 is a bottom, rear perspective view of the consumer product package of FIG. 1 in a partially folded position.

FIG. 6 is a bottom, rear perspective view of the consumer product package of FIG. 1 in a partially folded position.

FIG. 7 is a front, perspective view of the consumer product package of FIG. 1.

FIG. 8 is a front, perspective view of another possible embodiment of a consumer product package.

### DETAILED DESCRIPTION OF THE INVENTION

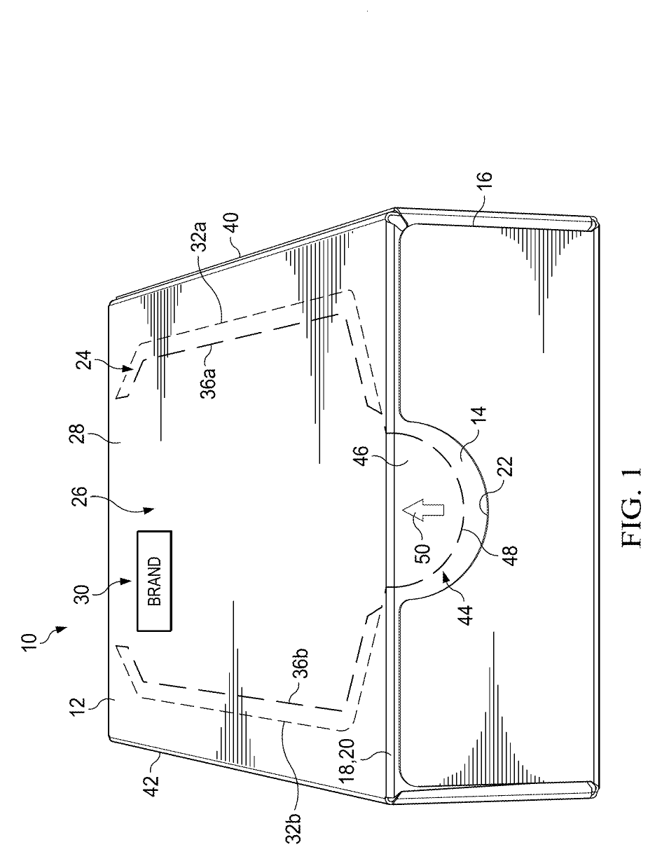

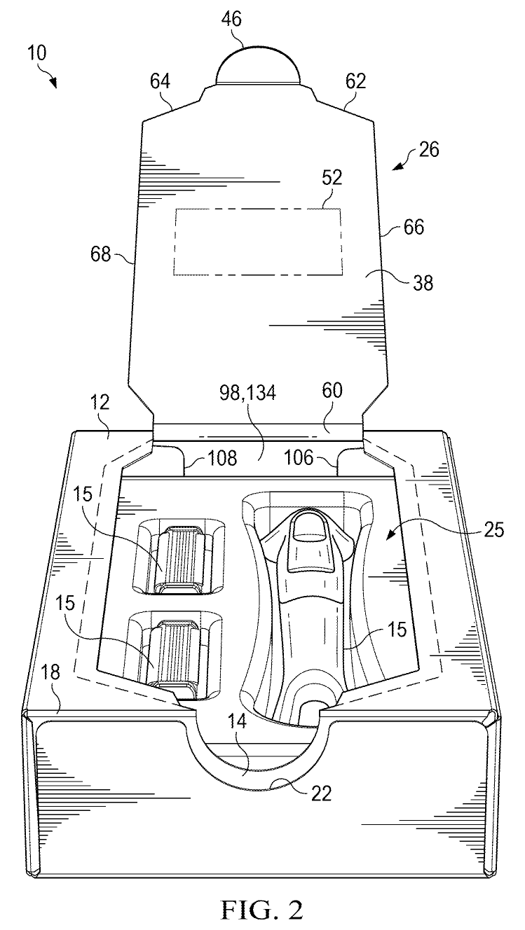

Referring to FIG. 1, one possible embodiment of the present invention is shown illustrating a consumer product package 10 in a sealed position. As will be explained in greater detail below, the consumer product package 10 may be folded from a sheet of formable material to create a box-like shape to contain one or more consumer products 15 (as shown in FIG. 2). The consumer product 15 may include personal grooming products such as toothbrushes, shaving razors, and shaving razor cartridges (FIG. 2). The consumer product package 10 may include a first panel 12, a second panel 14 and a third panel 16. The second panel 14 may extend from the first panel 12. The second panel 14 may be folded down such that the second panel 14 is perpendicular to the first panel 12, thus forming an edge 18. A fold line 20 may be positioned between the first panel 12 and the second panel 14 to facilitate folding. The third panel 16 may be folded over at least a portion the second panel 14. For example, the third panel 16 may define a cut away region 22 (e.g., a notch) that exposes a portion of the second panel 14. In certain embodiments, the cut away region 22 may be semi-circular in shape and dimensioned to receive a thumb or finger of a consumer to facilitate opening the consumer product package 10. However, it is understood that other shapes are also possible in order to receive the thumb or finger of a consumer. The third panel 16 may be attached to the second panel 14, for example, using pressure sensitive adhesive. As will be explained in greater detail below, the cut away region 22 may completely expose a punch out tab 46 to facilitate separating the punch out tab 46 from the second panel 14.

The first panel 12 may include a first weakened portion 24 defining a tear away region 26 to expose the cavity 25 (FIG. 2) defined by the consumer product package 10. The second weakened portion 24 may extend from the edge 18 into at least a portion of the first panel 12. In certain embodiments, the tear away region 26 may include a first surface 28 having branding 30 and/or other indicia or information about one or more products contained in the consumer product package 10. In certain embodiments, the first surface 28 may face away from the consumer on shelf. Accordingly, the tear away region 26 may not initially be visible to the consumer, which may allow for a cleaner appearance on shelf. However, it is understood that the first surface 28 may be consumer facing in certain embodiments.

The first weakened portion 24 may be defined by a pair of first border partial cuts 32a and 32b extending into the first surface 28 of the first panel 12 facing away from the cavity 25 (e.g., outer facing surface). The first weakened portion 24 may be defined by a pair of second border partial cuts 36a and 36b extending into a second surface (not shown) of the first panel 12 opposite the first surface 34 (e.g., the second surface may be an inner surface that faces the cavity 25). The second border partial cuts 36a and 36b may not be visible to a consumer. The first border partial cut 32a may be positioned between the second border partial cut 36a and an outer edge 40 of the first panel. Similarly, the first border cut 32bmay be positioned between the second border partial cut 36b and an outer edge 42 of the first panel 12. Although the pair of first border partial cuts 32a and 32b and the pair of second border partial cuts 36a and 36b are shown defining the first weakened portion 24, it is understood that the first weakened portion 24 may be defined by only one of the first border partial cuts 32a and 32b and only one of the second border partial cuts 36a and 36b. In addition, one or more of the border partial cuts 32a, 32b, 36a and 36b may include perforations, half cuts, slit lines or any combination thereof.

The second panel 14 may include a second weakened portion 44 that defines a punch out tab 46. The punch out tab 46 may extend from the edge 18 into at least a portion of the second panel 14. The punch out tab 46 may be part of the tear away region 26 (i.e., integral). In certain embodiments, the punch out tab 46 may be spaced apart from the cut way region 22 of the third panel 16 by about 0.75 mm to about 3.0 mm and more preferably about 1.0mm to about 2.0 mm to facilitate easy separation of the punch out tab 46 by a user’s thumb or finger. Accordingly, the cut way region 22 may expose the punch out tab 46. The second weakened portion 44 may include a plurality of spaced apart slits 48 that extend into the second panel 14. In certain embodiments, the spaced apart slits 48 may extend through the second panel 14 to facilitate separating the punch out tab 46 from the second panel 14. The spaced apart slits 48 that extend through the second panel 14 may also provide a better visual indicator for the user. The punch out tab 46 may include an indica 50, such as an arrow to indicate the consumer where to open the consumer product package 10. The punch out tab 46 may be a different color than the third panel 16 and/or the second panel 14 to further highlight the punch out tab 46 to a consumer. The second weakened portion 44 may extend to the first weakened portion 24, thus allowing a consumer to separate the punch out tab 46 from the second panel 14 and pull the punch out tab to remove the tear away region 26 from the first panel 12.

Referring to FIG. 2, a bottom rear perspective view of the consumer product package 10 of FIG. 1 is illustrated in an open position. The punch out tab 46 may be separated from the second panel 14 and lifted away from the cut out region 22 (FIG. 1). The tear away region 26 may be separated from the first panel 12 by pulling on the punch out tab 46 and rear along the first weakened portion 24 (FIG. 1). For example, the pair of first border partial cuts 32a and 32b and the pair of second partial border cuts 36a and 36b may facilitate the opening of tear away region 26 to reveal the cavity 25. The cavity 25 may be dimensioned to receive the consumer product 15, such as a shaving razor. In certain embodiments, the tear away region 26 may include an inner surface 38 having branding 52 and/or other indicia or information about the one or more consumer products 15 positioned within the cavity 25. The tear away region 26 may remain attached to the first panel 12 by a hinge segment 60. The hinge segment 60 may extend parallel to the edge 18. The tear away region 26 may include a pair of angled sides 62 and 64 that extend from the punch out tab 46 to a pair of corresponding parallel sides 66 and 68. A pair of angled sides 70 and 72 may extend from the hinge segment 60 to the corresponding parallel sides 66 and 68.

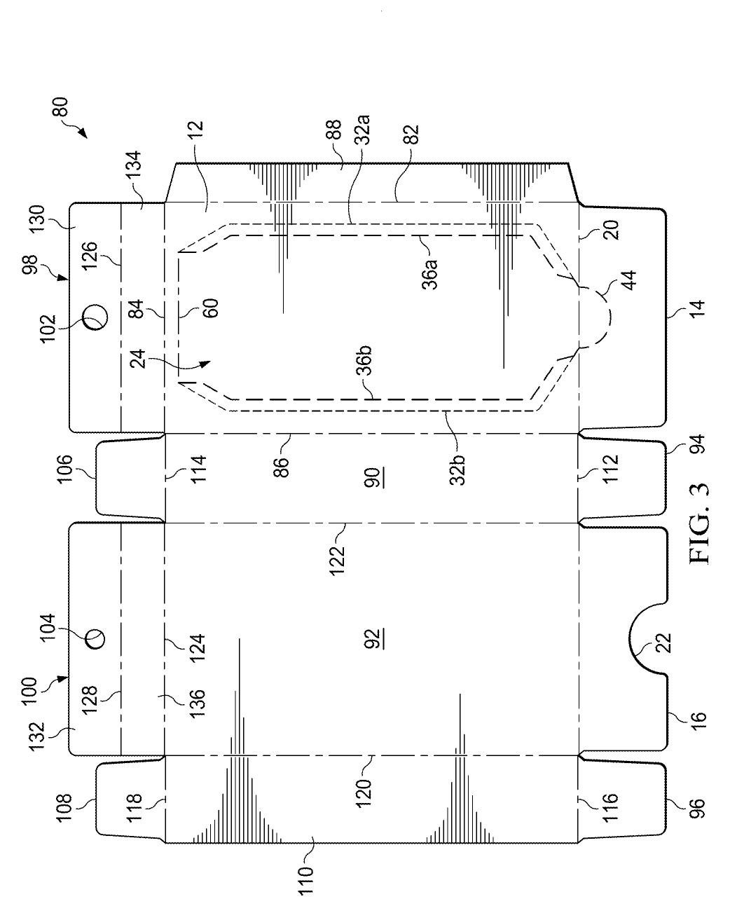

Referring to FIG. 3, a front view of a sheet of formable material 80 is shown in an unfolded position. The sheet 80 of formable material may be die cut from a single sheet of material. In certain embodiments, the sheet of formable material 80 may have a thickness of about 0.3mm to about 0.6mm. The sheet of formable material 80 may comprise paperboard, containerboard, and/or other sustainable materials. For example, the sheet of formable material 80 may include one or more cellulose-based products such as cardboard, paperboard, paper sheet, bamboo and other sustainable, compostable, biodegradable, or recycled/recyclable materials. The sheet 80 of formable material may have one or more surfaces that are coated and/or have printed graphics. However, it is understood graphics may be applied at any step of the process. For example, labels may be applied to the consumer product package 10 (FIG. 1) in lieu of or in addition two graphics printed directly on the sheet of formable material 80. The sheet of formable material 80 may be folded, glued, or otherwise secured into a final folded position resulting in the consumer product package 10, as shown in FIG. 1. In certain embodiments, the folding and gluing may be completed in multiple steps. For example, a first supplier may cut the sheet of formable material 80 and apply glue and fold certain portions before sending it to another location for final folding assembly where the product is packaged. Alternatively, all the steps may be completed as part of a single operation.

The first panel 12 may be defined by four fold lines 20, 82, 84 and 86. It is understood that fold lines 20, 82, 84 and 86may include numerous different manufacturing options to make the assembly process easier. When forming and folding a carton, the folding steps may be facilitated by providing crease lines, cut lines, perforations, partial cuts, slit scores, pre-break, or a combination of these. The term fold line is used as a general description of any of these techniques which may be used to facilitate accurate folding along a predetermined path. The fold line 20 positioned between the first panel 12 and the second panel 14 may facilitate the formation of the edge 18 (FIG. 1). The fold line 82 may be positioned between the first panel 12 and a side tab 88. The fold line 86 may be positioned between the first panel 12 and a fourth panel 90. The fourth panel 90 may be positioned between the first panel and a fifth panel 92. The fifth panel 92 may oppose the first panel 12 after folding is complete. A tab 94 may be positioned between the second panel 14 and the third panel 16. The third panel 16 may be positioned between the tab 94 and a tab 96.

A sixth panel 98 may extend from the first panel 12 (e.g., opposite the second panel 14). A seventh panel 100 may extend from the fifth panel 92 (e.g., opposite the third panel 16). The sixth panel 98 and the seventh panel 100 may each define a corresponding hang hole 102 and 104. The hang tag holes 102 and 104 can be any shape, such as a circle, oval, triangle or rectangle. Although the hang tag holes 102 and 104 are illustrated as bounded openings, the hang tag holes 102 and 104 may be unbounded (e.g., a “J” or hook shape configuration). A tab 106 may be located between the sixth panel 98 and the seventh panel 100. The seventh panel 100 may be positioned between a tab 108 and the tab 106. The fifth panel 92 may be positioned between an eighth panel 110 and the fourth panel 90. The tabs 96 and 108 may extend from the eighth panel 110.

The first weakened portion 24 may be formed by creating the first border partial cut 32. The first border partial cut 32a and 32b may extend approximately halfway of the thickness of the sheet of formable material 80. The first border partial cut 32 may not be continuous. For example, the first border partial cut 32a and 32b may include a plurality of spaced apart slits that can extend completely through the sheet of formable material or only to a certain depth. The term “partial” may refer to how far a cut is made into the sheet of formable material 80 and/or if the cut extends continuously compared to spaced apart cuts. In certain embodiments, the consumer product package 10 of FIG. 1 may also include the first weakened portion 24 having the second border partial cut 36a and 36b spaced apart from the first border partial cut 32a and 32b. In certain embodiments, the first border partial cut 32a and 32b and the second border partial cut 36a and 36b may be spaced apart except where the meet along at the hinge segment 60 and/or at the second weakened portion 44. The hinge segment 60 may include crease lines, cut lines, perforations, partial cuts, slit scores, pre-break, or a combination of these. Accordingly, the consumer may completely rip the tear away region 26 (FIG. 1) away from the rest of the consumer product package 10 or the consumer may allow the tear away region 26 connected to the rest of the consumer product package 10 along the hinge segment 60, as shown in FIG. 2.

The second weakened portion 44 may include cut lines, perforations, partial cuts, slit scores, pre-break, or a combination of these to facilitate separating the punch out tab 46 from the second panel 14. The second border partial cut 36a and 36b may extend approximately halfway of the thickness of the sheet of formable material 80. The second border partial cut 36a and 36b may not be continuous. For example, second border partial cut 36a and 36b may include a plurality of spaced apart slits that can extend completely through the sheet of formable material or only to a certain depth. The term “partial” may refer to how far a cut is made into the sheet of formable material 80 and/or if the cut extends continuously compared to spaced apart cuts. The second weakened portion 44 may extend from the fold line 20 and the first weakened portion 24 may extend up to the fold line 20. In certain embodiments, a cut lines, perforations, partial cuts, slit scores, pre-break, or a combination of these from the first weakened portion 24 and/or the second weakened portion 44 may not extend through the fold line 20, which may cause inadvertent separation of the punch out tab 46 from the second panel 14.

The tab 106 may be folded such that it is perpendicular to the fourth panel 90. The tab 106 may be folded along the fold line 114. The tab 108 may be folded such that it is perpendicular to the eighth panel 110. The tab 108 may be folded along the fold line 118. The eighth panel 110 may be folded along a fold line 120 such that the eighth panel 110 is perpendicular to the fifth panel 92. The side tab 88 may be folded along the fold line 82 such that the side tab 88 is perpendicular to the first panel 12. The fourth panel 90 may be folded along the fold line 86, such that the fourth panel 90 is perpendicular to the first panel 12. Accordingly, the fifth panel 92 may be temporarily perpendicular to the first panel 12. The fifth panel 92 may then be folded along a fold line 122 positioned between the fifth panel 92 and the fourth panel 90, such that the fifth panel 92 is perpendicular to the fourth panel 90 (and perpendicular the folded tabs 94 and 106) and parallel to the first panel 12 (e.g., the first panel 12 and the fifth panel 92 may be opposing each other when folded). The eighth panel 110 may thus become parallel to the fourth panel 90 and the side tab 88 may be positioned inside of the eighth panel 110). The eight panel 110 and the side tab 88 may be bonded together with adhesive, such as a pressure sensitive adhesive.

The tabs 106 and 108 may be folded against a lower portion 134 of the sixth panel 98 and lower portion 136 of the seventh panel 100. The tabs 106 and 108 may be sealed against the lower portions 134 and 136 using a pressure sensitive adhesive. A fold line 118 may be positioned between the tab 108 and the eighth panel 110 to facilitate the folding of the tab 108. A fold line 116 may be positioned between the tab 96 and the eighth panel 110 to facilitate the folding of the tab 96. A fold line 112 may be positioned between the tab 94 and the fourth panel 90 to facilitate the folding of the tab 94. A fold line 114 may be positioned between the tab 106 and the fourth panel 90 to facilitate the folding of the tab 106.

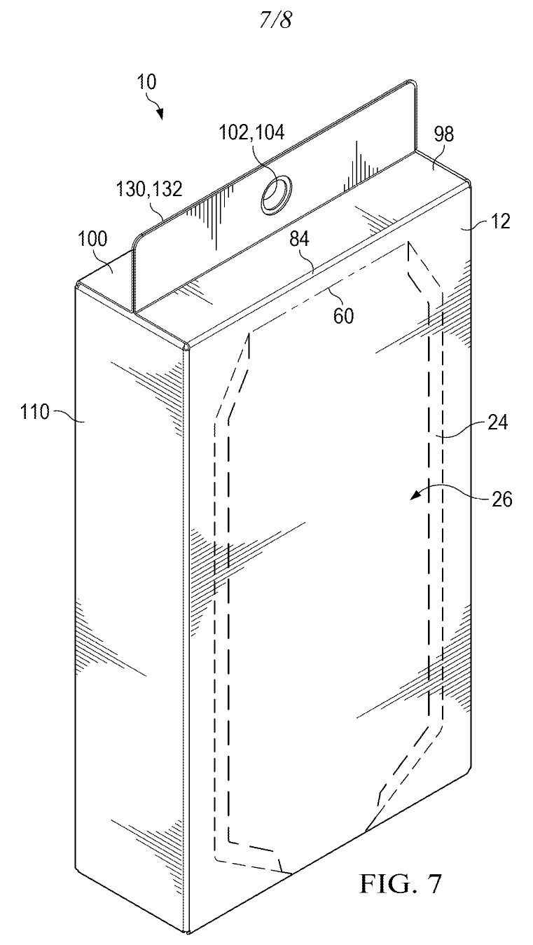

Referring to FIGS. 3 and 7, the sixth panel 98 may be folded against the seventh panel 100 such that the hang hole openings 102 and 104 are generally concentric, to facilitate receiving a display peg (not shown). The sixth panel 98 may bond to the seventh panel 100, for example, using a pressure sensitive adhesive. The sixth panel 98 may be folded along the fold line 84 such that the sixth panel 98 is perpendicular to the first panel 12. The seventh panel 100 may be folded along a fold line 124 between the seventh panel 100 and the fifth panel 92 such that the seventh panel 100 is perpendicular to the fifth panel 92. A fold line 126 may be provided between the handle hole 102 and the fold line 84. Similarly, a fold line 128 may be positioned between the hang hole 104 and the fold line 124. Accordingly, an upper portion 130 of the sixth panel 98 and an upper portion 132 of the seventh panel 100 may be folded to be perpendicular to the first panel 12 and the fifth panel 92, thus allowing the consumer product package 10 to be hung on a product display peg (not shown), with the first panel 12 or the fifth panel 92 facing a potential purchaser.

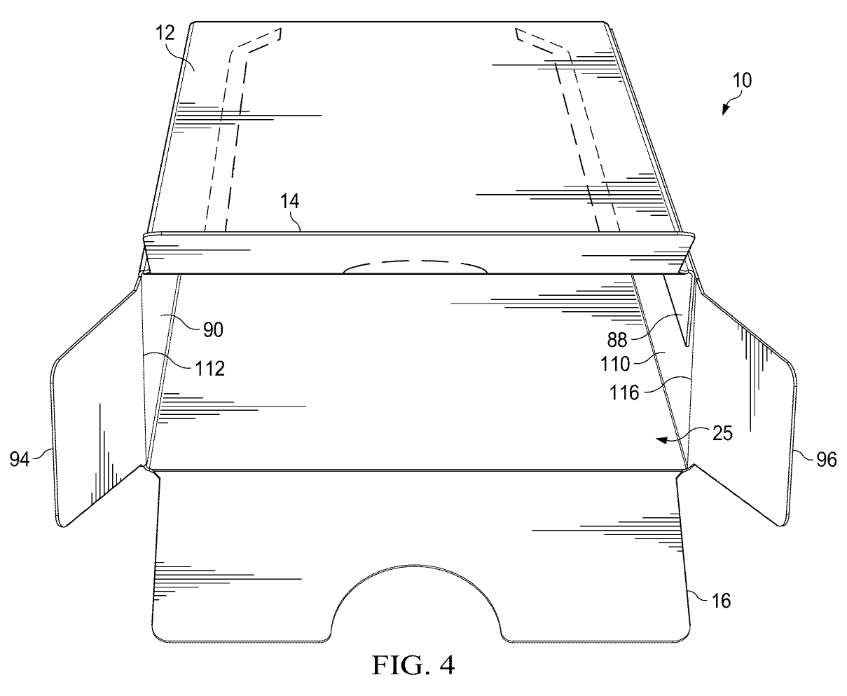

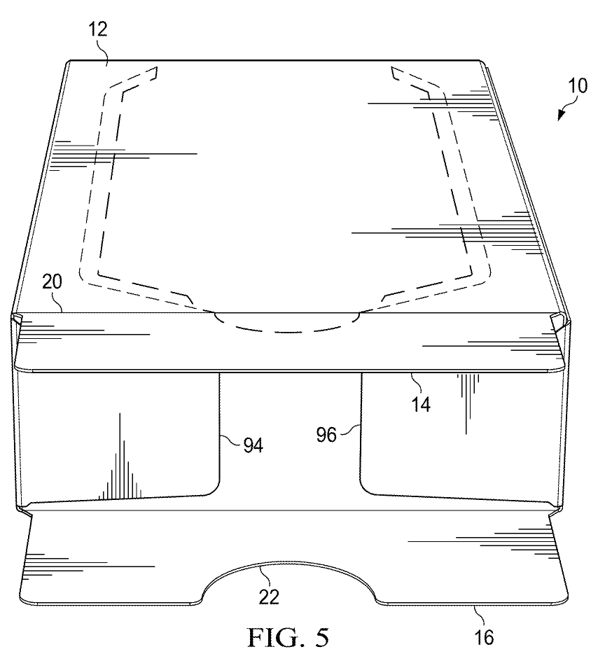

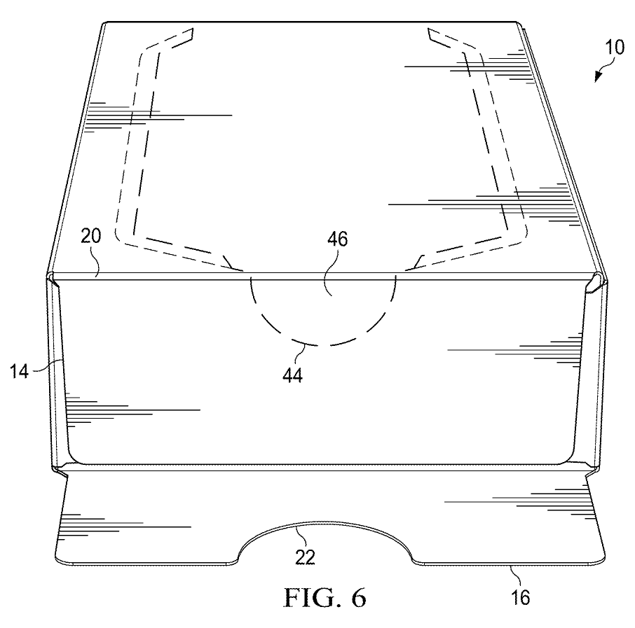

Referring to FIG. 4, front, bottom perspective view of the consumer product package 10 is shown in a partially folded position to allow insertion of the consumer product 15 (FIG. 2). The consumer product package 10 (i.e., the cavity 25) may be dimensioned to receive the consumer product 15 (FIG. 2). Once the one or more consumer products 15 are positioned within the cavity 25, the tabs 94 and 96 may be folded inwardly toward the cavity 25, as shown in FIG. 5. The tab 94 may be folded along the fold line 112 such that it is generally perpendicular to the fourth panel 90. The tab 96 may be folded along the fold line 116 such that it is generally perpendicular to the eighth panel 110. The second panel 14 may be folded along the fold line 20 (FIG. 3) and over the tabs 94 and 96 such that the second panel 14 is generally perpendicular to the first panel 12, as shown in FIG. 6. The third panel 16 may then be folded against the second panel 14 with the punch out tab 46 spaced apart from the cut away region 22 of the third panel 16, as shown in FIG. 1. The third panel 16 may be bonded to the second panel 14, for example, using pressure sensitive adhesive. The bonding of the third panel 16 to the second panel 14 may facilitate the opening of the consumer product package 10 by a consumer by making it easier to break the second weakened portion 44. Accordingly, the strength of the bond between the second panel 14 and the third panel 14 should be greater than the force to break the second weakened portion 44 and thus separate the punch out tab 46 from the second panel 14.

It is understood that the second weakened portion 44 that defines the punch out tab 46 may be located on other panels other than the second panel 14 (which is opposite the upper portion 130 of the sixth panel 98 and the upper portion 132 of the seventh panel 100 that define upper portion 130 of the sixth panel 98 and an upper portion 132 of the seventh panel 100 that define the hang tag holes 102 and 104). For example, the second weakened portion 44 that defines the punch out tab 46 may be located adjacent to the upper portion 130 of the sixth panel 98, that defines the hang tag hole 102.

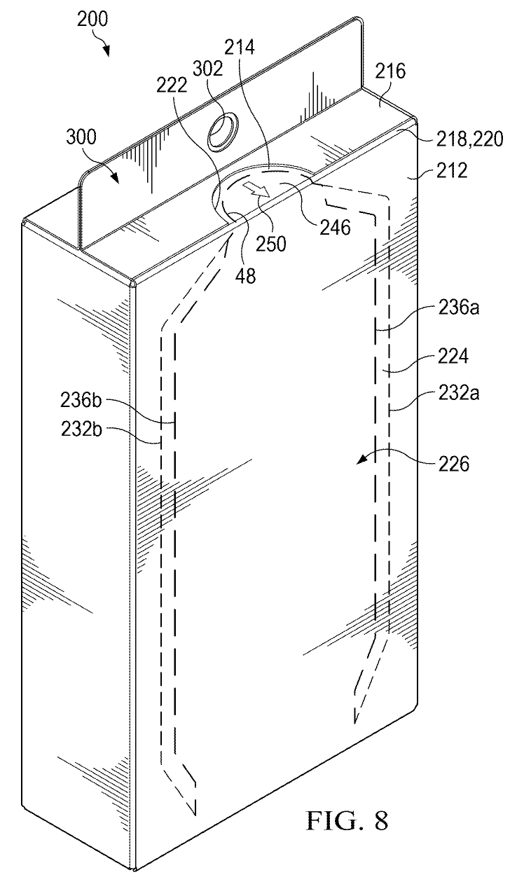

As shown in FIG. 8, a consumer product package 200 may be folded from a sheet of formable material to create a box-like shape to contain one or more of the consumer products 15 (e.g., as shown in FIG. 2). The consumer product package 200 may include a first panel 212, a second panel 214 and a third panel 216. The second panel 214 may extend from the first panel 212. The second panel 214 may be folded down such that the second panel 214 is perpendicular to the first panel 212, thus forming an edge 218. A fold line 220 may be positioned between the first panel 212 and the second panel 214 to facilitate folding. The third panel 216 may be folded over at least a portion of the second panel 214. For example, the third panel 216 may define a cut away region 222 (e.g., a notch) that exposes a portion of the second panel 214. In certain embodiments, the cut away region 222 may be semi-circular in shape and dimensioned to receive a thumb or finger of a consumer to facilitate opening the consumer product package 10. However, it is understood that other shapes are also possible in order to receive the thumb or finger of a consumer. The third panel 216 may be attached to the second panel 214, for example, using pressure sensitive adhesive. The cut away region 222 may completely expose a punch out tab 46 to facilitate separating the punch out tab 246 from the second panel 214.

The first panel 212 may include a first weakened portion 224 defining a tear away region 226 to expose an inner cavity 25 defined by the consumer product package 200. The second weakened portion 224 may extend from the edge 218 into at least a portion of the first panel 212. The first weakened portion 224 may be defined by a pair of first border partial cuts 232a and 232b extending into a first surface 226 the first panel 212. The first weakened portion 224 may be defined by a pair of second border partial cuts 236a and 236b extending into a second surface (not shown) of the first panel 212 opposite the first surface 234. The second border partial cuts 236aand 236bmay not be visible to a consumer. Although the pair of first border partial cuts 232aand 232b and the pair of second border partial cuts 236a and 236b are shown defining the first weakened portion 24, it is understood that the first weakened portion 24 may be defined by perforations, half cuts, slit lines or any combination thereof.

The second panel 214 may include a second weakened portion 244 that defines a punch out tab 246. The punch out tab 246 may extend from the edge 218 into at least a portion of the second panel 214. The punch out tab 46 may be part of the tear away region 226 (i.e., integral). In certain embodiments, the punch out tab 246 may be part of the tear away region 226 (i.e., integral). In certain embodiments, the punch out tab 246 may be spaced apart from the cut way region 222 of the third panel 216 by about 0.75 mm to about 3.0 mm and more preferably about 1.0mm to about 2.0 mm to facilitate easy separation of the punch out tab 46 by a user’s thumb or finger. Accordingly, the cut way region 222 may expose the punch out tab 246. The second weakened portion 244 may include a plurality of spaced apart slits 248 that extend into the second panel 214. In certain embodiments, the spaced apart slits 248 may extend through the second panel 214 to facilitate separating the punch out tab 246 from the second panel 214. The spaced apart slits 248 that extend through the second panel 214 may also provide a better visual indicator for the user. The punch out tab 246 may include an indica 250, such as an arrow to indicate the consumer where to open the consumer product package 200. The punch out tab 246 may be a different color than the third panel 216 and/or the second panel 214 to further highlight the punch out tab 246 to a consumer. The second weakened portion 244 may extend to the first weakened portion 224, thus allowing a consumer to separate the punch out tab 246 from the second panel 214 and pull the punch out tab to remove the tear away region 226 from the first panel 212.

A hang panel 300 may extend from the third panel 216 (e.g., generally perpendicular to the third panel 216). The hang panel 300 may define a hang hole 302 dimensioned to receive a display peg (not shown). The positioning of the punch out tab 246 adjacent to the hang panel 300 that is generally perpendicular to the punch out tab 246 and the third panel 216 may facilitate the opening of the consumer product package 200 (i.e., the removal of the tear away region 226). For example, a consumer may grasp the hang panel 300 with one hand and use their other hand to engage the punch out tab 246 and remove the tear away region 226 from the first panel 212.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Furthermore, dimensions should not be held to an impossibly high standard of metaphysical identity that does not allow for discrepancies due to typical manufacturing tolerances. Therefore, the term “about” should be interpreted as being within typical manufacturing tolerances.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer product package defining a cavity dimensioned to receive a product, the consumer product package comprising:
a first panel;
a second panel extending in a transverse direction from the first panel;
an edge between the first panel and the second panel;
a first weakened portion defining a tear away region to expose the cavity, the second weakened portion extending from the edge into at least a portion of the first panel;
a second weakened portion defining a punch out tab extending from the edge into at least a portion of the second panel;
a third panel positioned over the second panel, the third panel defines a cut away region exposing the punch out tab, wherein the punchout tab and the tear away region are integral.

2. The consumer product box of claim 1 wherein the cut away region completely exposes the punch out tab.

3. The consumer product box of claim 1 wherein the first weakened portion comprises a hinge segment that extends parallel to the edge.

4. The consumer product box of claim 3 wherein the first weakened portion comprises a pair of parallel segments extending between the hinge segment and edge.

5. The consumer product box of claim 1 wherein the first weakened portion comprises a first border partial cut extending into a first surface of the first panel facing away from the cavity.

6. The consumer product box of claim 1 wherein the first weakened portion comprises a second border partial cut extending into a second surface of the first panel facing the cavity.

7. The consumer product box of claim 5 wherein the first weakened portion comprises a second border partial cut extending into a second surface of the first panel facing the cavity.

8. The consumer product box of claim 7 wherein the first border partial cut is positioned between the second border partial cut and an outer edge of the first panel.

9. The consumer product box of claim 1 wherein the punch out tab is semi-circular.

10. The consumer product box of claim 1 wherein the cut away region is semi-circular.

11. The consumer product box of claim 1 wherein the first weakened portion comprises a first pair of angled segments that extend toward a pair of outer edges of the first panel.

12. The consumer product box of claim 11 wherein the first pair of angled segments extend to a corresponding pair of parallel segments.

13. The consumer product box of claim 12 wherein the first weakened portion comprises a hinge segment that extends parallel to the edge.

14. The consumer product box of claim 13 wherein the first pair of parallel segments extend between the hinge segment and the pair of angled segments.

15. The consumer product box of claim 14 wherein the first weakened portion comprises a second pair of angled segments that extend from the hinge segment to the pair of parallel segments.

16. The consumer product box of claim 15 wherein the second pair of angled segments extend outwardly from the hinge segment toward the outer edges of the first panel.

17. The consumer product box of claim 1 wherein a second surface of the first panel facing the cavity comprises messaging indicia.

18. A method of forming a consumer product box defining a cavity dimensioned to receive a product, comprising the steps of:
forming a first weakened portion defining a tear away region in at least a portion of the first panel to expose the cavity;
forming a second weakened portion defining a punch out tab in at least a portion of a second panel that is transverse to and integral with the first panel;
covering the first panel with a third panel; and
positioning a cut away region defined by the third panel around the punch out tab exposing the punch out tab.

19. The consumer product box of claim 18 wherein said forming the first weakened portion comprises forming a hinge segment in the first panel that extends parallel to an edge between the first panel and the second panel.

20. The consumer product box of claim 18 wherein said forming the first weakened portion comprises forming a pair of parallel segments extending between the hinge segment and the edge between the first panel and the second panel.
